(19) United States
(12) Patent Application Publication
(10) Pub. No.: US 2026/0331017 A1
(43) Pub. Date: Oct. 22, 2026

(54) DISPLAY DEVICE, ELECTRONIC DEVICE, AND CALIBRATION METHOD THEREOF

(71) Applicant: SAMSUNG ELECTRONICS CO., LTD., Suwon-si (KR)

(72) Inventors: Minjung KIM, Suwon-si (KR); Namkyun Beon, Suwon-si (KR)

(73) Assignee: SAMSUNG ELECTRONICS CO., LTD., Suwon-si (KR)

(21) Appl. No.: 19/468,478

(22) Filed: Feb. 3, 2026

Related U.S. Application Data
(63) Continuation of application No. PCT/KR2024/012092, filed on Aug. 14, 2024.

(30) Foreign Application Priority Data
Sep. 21, 2023 (KR) 10-2023-0126654

(51) Int. Cl. G09G 3/20; G09G 3/32

(52) U.S. Cl. CPC G09G 3/2007; G09G 3/32; G09G 2300/0452; G09G 2320/0233; G09G 2320/0242; G09G 2320/0693; G09G 2360/16

(57) ABSTRACT

A calibration method of a plurality of light-emitting diode (LED) pixels of a display apparatus, includes: obtaining a first correction coefficient that corresponds to each of a plurality of LED pixels and corresponds to a high grayscale that is greater than or equal to a threshold grayscale; and obtaining a second correction coefficient that corresponds to each of the plurality of LED pixels and corresponds to a low grayscale that is less than the threshold grayscale, wherein the obtaining the second correction coefficient includes: obtaining the second correction coefficient based on the first correction coefficient and a third correction coefficient corresponding to a low grayscale measured for each red, green, and blue color for each pixel group including a plurality of LED pixels, or obtaining the second correction coefficient based on the first correction coefficient and a white luminance value corresponding to a low grayscale measured for each pixel group.

### CROSS-REFERENCE TO RELATED APPLICATIONS

This application is continuation of International Application No. PCT/KR2024/012092, filed on Aug. 14, 2024, which is based on and claims priority to Korean Patent Application No. 10-2023-0126654, filed on Sep. 21, 2023, in the Korean Intellectual Property Office, the disclosures of which are incorporated by reference herein in their entireties.

### BACKGROUND

### 1. Field

The disclosure relates to a display apparatus, an electronic apparatus, and a calibration method thereof, and more particularly to a display apparatus that includes light-emitting diode (LED) pixels, an electronic apparatus, and a control method thereof.

### 2. Description of Related Art

With developments in electronic technology, electronic devices of various types are being developed and supplied. Specifically, display apparatuses used in various locations such as a household, an office, a public location, and the like have been under continuous development for several years recently.

An LED display is configured with a screen by assembling a module type configured with several LED pixels. The LED display may be installed on roads, subway stations, shopping malls, sports stadiums, homes, offices, and the like for various purposes. As types of LED displays have become varied, types of content being displayed have become varied accordingly, not only high grayscale, but also low grayscale and ultra-low grayscale characteristics have become important. However, there is a problem in that when measuring a low grayscale of low value, luminance may be low and may not be measured at all in a measuring device, or even if measured, reliability of the measured data may be low. For example, there is a problem of distinguishing of noise and data being difficult and noise being identified as data or data being identified as noise.

### SUMMARY

According to an aspect of the disclosure, a display apparatus includes: a display including a plurality of light-emitting diode (LED) pixels; memory storing a first correction coefficient that corresponds to each of the plurality of LED pixels and corresponds to a high grayscale that is greater than or equal to a threshold grayscale, and a second correction coefficient that corresponds to a low grayscale that is less than the threshold grayscale; and one or more processors configured to drive the display by applying a correction coefficient for each grayscale obtained based on the first correction coefficient and the second correction coefficient to each of the plurality of LED pixels, wherein the second correction coefficient is obtained based on the first correction coefficient and a third correction coefficient corresponding to a low grayscale measured for each red, green, and blue color for each pixel group including a plurality of LED pixels, or obtained based on the first correction coefficient and a white luminance value corresponding to a low grayscale measured for each pixel group.

The second correction coefficient may be obtained based on calculation of the first correction coefficient for each pixel and the third correction coefficient for each pixel.

The first correction coefficient for each of the pixels may include a high grayscale correction coefficient for each pixel, the third correction coefficient for each of the pixels may include a low grayscale correction coefficient for each pixel measured for each red, green, and blue color for each pixel group that includes a plurality of LED pixels, and a value of the first correction coefficient and the third correction coefficient may include a low grayscale correction coefficient value corresponding to each of a plurality of pixels included in each pixel group.

The second correction coefficient may be obtained based on a luminance value for each red, green, and blue color corresponding to an obtained low grayscale for each pixel when a luminance value for each red, green, and blue color corresponding to a low grayscale for each pixel is obtained based on high grayscale red, green, blue, and white luminance values and a white luminance value corresponding to a low grayscale measured for each of the pixel groups.

The third correction coefficient may be obtained by measuring a low grayscale value by simultaneously turning-on a plurality of LED pixels included in a pixel group for each red, green, and blue color.

According to an aspect of the disclosure, an electronic apparatus includes: a camera; memory storing at least one instruction; and one or more processors operatively coupled with the camera and the memory, wherein the at least one instruction, when executed by the one or more processors individually or collectively, causes the electronic apparatus to: obtain a first correction coefficient that corresponds to each of a plurality of light-emitting diode (LED) pixels included in a display apparatus and corresponds to a high grayscale that is greater than or equal to a threshold grayscale based on captured data obtained through the camera, and obtain a second correction coefficient that corresponds to each of the plurality of LED pixels and corresponds to a low grayscale that is less than the threshold value, and wherein the at least one instruction, when executed by the one or more processors individually or collectively, may cause the electronic apparatus to: obtain the second correction coefficient based on the first correction coefficient and a third correction coefficient corresponding to a low grayscale measured for each pixel group including a plurality of LED pixels, or obtain the second correction coefficient based on the first correction coefficient and a white luminance value corresponding to a low grayscale measured for each pixel group.

The at least one instruction, when executed by the one or more processors individually or collectively, may cause the electronic apparatus to obtain the second correction coefficient based on calculation of the first correction coefficient for each pixel and the third correction coefficient for each pixel.

The first correction coefficient for each of the pixels may include a high grayscale correction coefficient for each pixel, the third correction coefficient for each of the pixels may include a low grayscale correction coefficient for each pixel measured for each pixel group that includes a plurality of LED pixels, and calculation of the first correction coefficient and the third correction coefficient may include a low grayscale correction coefficient value corresponding to a plurality of pixels included in each pixel group.

The at least one instruction, when executed by the one or more processors individually or collectively, may cause the electronic apparatus to: obtain a luminance value for each red, green, and blue color corresponding to a low grayscale for each pixel based on high grayscale red, green, blue, and white luminance values and a white luminance value corresponding to a low grayscale measured for each of the pixel groups, and obtain the second correction coefficient based on a luminance value for each red, green, and blue color corresponding to the obtained low grayscale for each pixel.

The at least one instruction, when executed by the one or more processors individually or collectively, may cause the electronic apparatus to obtain the third correction coefficient by measuring a low grayscale value by simultaneously turning-on a plurality of LED pixels included in a pixel group for each red, green, and blue color.

The at least one instruction, when executed by the one or more processors individually or collectively, may cause the electronic apparatus to obtain the third correction coefficient by measuring a low grayscale value by simultaneously turning-on an n x n-number of pixels from a position spaced apart by a m-number of pixels for each red, green, and blue color.

The at least one instruction, when executed by the one or more processors individually or collectively, may cause the electronic apparatus to obtain a white luminance value corresponding to the low grayscale by simultaneously turning-on red, green, and blue pixels corresponding to a plurality of LED pixels included in a pixel group.

According to an aspect of the disclosure, a calibration method of a plurality of light-emitting diode (LED) pixels of a display apparatus, includes: obtaining a first correction coefficient that corresponds to each of a plurality of LED pixels and corresponds to a high grayscale that is greater than or equal to a threshold grayscale; and obtaining a second correction coefficient that corresponds to each of the plurality of LED pixels and corresponds to a low grayscale that is less than the threshold grayscale, wherein the obtaining the second correction coefficient includes: obtaining the second correction coefficient based on the first correction coefficient and a third correction coefficient corresponding to a low grayscale measured for each red, green, and blue color for each pixel group including a plurality of LED pixels, or obtaining the second correction coefficient based on the first correction coefficient and a white luminance value corresponding to a low grayscale measured for each pixel group.

The obtaining a second correction coefficient may include obtaining the second correction coefficient based on calculation of the first correction coefficient for each pixel and the third correction coefficient for each pixel.

According to an aspect of the disclosure, a non-transitory computer-readable media stores computer instructions that are executed by at least one processor of a display apparatus to perform calibration method of a plurality of light-emitting diode (LED) pixels of the display apparatus, the calibration including: obtaining a first correction coefficient that corresponds to each of the plurality of LED pixels and corresponds to a high grayscale that is greater than or equal to a threshold grayscale; and obtaining a second correction coefficient that corresponds to each of the plurality of LED pixels and corresponds to a low grayscale that is less than the threshold grayscale, wherein the obtaining a second correction coefficient includes: obtaining the second correction coefficient based on the first correction coefficient and a third correction coefficient corresponding to a low grayscale measured for each red, green, and blue color for each pixel group including a plurality of LED pixels, or obtaining the second correction coefficient based on the first correction coefficient and a white luminance value corresponding to a low grayscale measured for each pixel group.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an LED calibration method according to one or more embodiments;

FIG. 2 is a block diagram illustrating a configuration of a display apparatus according to one or more embodiments;

FIG. 3 is a block diagram illustrating a detailed configuration of a display apparatus according to one or more embodiments;

FIG. 4A is a block diagram illustrating a configuration of an electronic apparatus according to one or more embodiments;

FIG. 4B is a block diagram illustrating a detailed configuration of an electronic apparatus according to one or more embodiments;

FIG. 5 is a flowchart illustrating a calibration method of a display apparatus that used an electronic apparatus according to an embodiment;

FIGS. 6A, 6B, and 6C are diagrams illustrating a low grayscale calibration method according to one or more embodiments;

FIG. 7 is a flowchart illustrating a calibration method of a display apparatus that used an electronic apparatus according to one or more embodiments; and

FIGS. 8 and 9 are diagrams illustrating a low grayscale calibration method according to one or more embodiments.

### DETAILED DESCRIPTION

Terms used in the disclosure will be briefly described, and the disclosure will be described in detail.

Terms used in describing the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, “at least one of A and B” or “one or more of A or B” may include all possible combinations of the items listed together. For example, “A or B”, “at least one of A and B”, or “at least one of A or B” may refer to all cases including (1) only A, (2) only B, or (3) both A and B.

Expressions such as “1st”, “2nd”, “first”, or “second” used in the disclosure may limit various elements regardless of order and/or importance, and may be used merely to distinguish one element from another element and not limit the relevant element.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element).

The expression “configured to… (or set up to)” used in the disclosure may be used interchangeably with, for example, “suitable for…”, “having the capacity to…”, “designed to…”, “adapted to…”, “made to…”, or “capable of…” based on circumstance. The term “configured to… (or set up to)” may not necessarily mean “specifically designed to” in terms of hardware.

In a certain circumstance, the expression “a device configured to…” may mean something that the device “may perform…” together with another device or components. For example, a phrase “a sub-processor configured to (or set up to) perform A, B, or C” may mean a dedicated processor (e.g., embedded processor) for performing a relevant operation, or a generic-purpose processor (e.g., central processing unit (CPU) or application processor) capable of performing the relevant operations by executing one or more software programs stored in a memory device.

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used in the embodiments herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

The various elements and areas in the drawings have been schematically illustrated. Accordingly, the technical spirit of the disclosure is not limited by relative sizes and distances illustrated in the accompanied drawings.

An embodiment of the disclosure will be described in greater detail with reference to the accompanied drawings below.

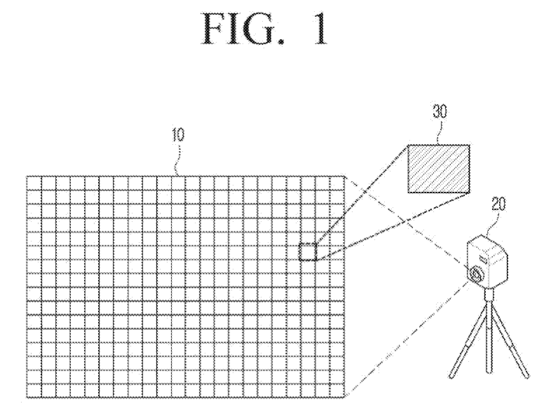

FIG. 1 is a diagram illustrating a light-emitting diode (LED) calibration method according to one or more embodiments.

As shown in FIG. 1, a display apparatus 10 according to one or more embodiments may include a plurality of pixels arranged in a matrix form. For example, the display apparatus 10 may be implemented in a form that physically connected a plurality of display modules. Here, each of the plurality of display modules may include a plurality of pixels, for example self-emissive pixels, arranged in matrix form. Specifically, a display module may be implemented as an LED module in which each of the plurality of pixels is implemented as LED pixels or as an LED cabinet connected with a plurality of LED modules, but is not limited thereto. For example, the display module may be implemented as an organic LED (OLED), a quantum dot LED (QLED), an active-matrix OLED (AMOLED), and the like. However, for convenience of description below, each of the display modules may be described assuming the same being implemented as the LED module or the LED cabinet.

According to an example, a correction coefficient calibrated for pixel uniformity (or display uniformity) that form each of the plurality of display modules may be calculated. For example, the correction coefficient may be calculated by a separate electronic apparatus 20 (e.g., colorimeter, color difference meter, measuring device, PC, etc.). In this case, the electronic apparatus 20 may include a camera (a measuring device) for capturing of the display apparatus 10, or it may be possible to receive a captured image (data) from an external capturing device.

According to an example, when calibrating the display apparatus 10 formed of LED pixels, there is a possibility of uniformity characteristics in low grayscale and ultra-low grayscale being identified as inferior compared to those in high grayscale. To this end, calculating the correction coefficient by measuring at a lower ultra-low grayscale than before may be required.

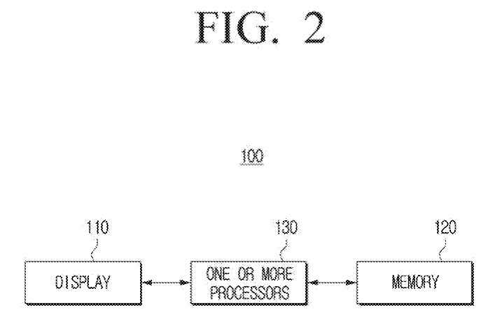

FIG. 2 is a block diagram illustrating a configuration of a display apparatus according to one or more embodiments.

Referring to FIG. 2, a display apparatus 100 may include a display 110, memory 120, and one or more processors 130.

The display 110 may include a plurality of display modules. Specifically, the display 110 may be configured in an assembled form by connecting the plurality of display modules. Here, each of the plurality of display modules may include a plurality of pixels, for example self-emissive pixels, arranged in matrix form. According to an embodiment, the display 110 may be implemented with a plurality of LED modules (an LED module including at least one LED device) and/or a plurality of LED cabinets. In addition, an LED module may include a plurality of LED pixels, and an LED pixel according to an example may be implemented as an RGB LED, and the RGB LED may include a RED LED, a GREEN LED, and a BLUE LED together therewith.

The memory 120 may store data necessary for various embodiments. The memory 120 may be implemented in a form of a memory embedded in a display apparatus 100’ according to data storage use, or implemented in a form of a memory attachable to or detachable from the display apparatus 100’. For example, data for driving the display apparatus 100’ may be stored in the memory embedded in the display apparatus 100’, and data for an expansion function of the display apparatus 100’ may be stored in the memory attachable to or detachable from the display apparatus 100’. The memory embedded in the display apparatus 100’ may be implemented as at least one of a volatile memory (e.g., dynamic RAM (DRAM), static RAM (SRAM), or synchronous dynamic RAM (SDRAM)), or a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard disk drive (HDD) or solid state drive (SSD)). In addition, the memory attachable to or detachable from the display apparatus 100’ may be implemented in a form such as, for example, and without limitation, a memory card (e.g., compact flash (CF), secure digital (SD), micro secure digital (micro-SD), mini secure digital (mini-SD), extreme digital (xD), multi-media card (MMC), etc.), an external memory (e.g., USB memory) connectable to a USB port, or the like.

The memory 120 may store correction coefficients corresponding to emissive pixels that form the plurality of display modules. According to an example, the memory 120 may store correction coefficients corresponding to each of the emissive pixels that form each of the plurality of display modules.

According to an example, the memory 120 may be stored with a high grayscale correction coefficient (hereinafter, referred to as ‘first correction coefficient’) and a low grayscale correction coefficient (hereinafter, referred to as ‘second correction coefficient’) for each LED pixel.

According to an example, a second correction coefficient may be obtained based on a first correction coefficient and a third correction coefficient corresponding to a low grayscale for each pixel measured for each pixel group including a plurality of LED pixels. For example, the second correction coefficient may be a value obtained based on a calculation of the first correction coefficient for each pixel, the third correction coefficient for each pixel, and the first correction coefficient and the third correction coefficient for each pixel. For example, a calculation result of the first correction coefficient and the third correction coefficient may be the low grayscale correction coefficient.

According to another example, the second correction coefficient may be a value obtained based on the first correction coefficient and a white (W) luminance value corresponding to the low grayscale measured for each pixel group. For example, the second correction coefficient may be a value obtained based on a luminance value for each R, G, and B color corresponding to a low grayscale for each pixel. In this case, the luminance value for each R, G, and B color corresponding to the low grayscale for each pixel may be obtained through calculation of high grayscale R, G, B, and W luminance values and the W luminance value corresponding to the low grayscale measured for each pixel group.

The one or more processors 130 may control an operation of the display apparatus 100 overall. Specifically, the one or more processors 130 may control the operation of the display apparatus 100 overall by being connected with each configuration of the display apparatus 100. For example, the one or more processors 130 may control the overall operation of the display apparatus 100 by being electrically connected with the display 110 and the memory 120. The one or more processors 130 may be formed with one or a plurality of processors.

The one or more processors 130 may perform, by executing at least one instruction stored in the memory 120, an operation of the display apparatus 100 according to various embodiments.

The one or more processors 130 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or a random combination from among other elements of an electronic apparatus, and perform an operation associated with communication or data processing. The one or more processors 130 may execute one or more programs or instructions stored in the memory. For example, the one or more processors may perform, by executing one or more instructions stored in the memory, a method according to one or more embodiments of the disclosure.

When a method according to one or more embodiments of the disclosure includes a plurality of operations, the plurality of operations may be performed by one processor, or performed by a plurality of processors. For example, when a first operation, a second operation, and a third operation are performed by a method according to one or more embodiments, the first operation, the second operation, and the third operation may all be performed by a first processor, or the first operation and the second operation may be performed by the first processor (e.g., generic-purpose processor) and the third operation may be performed by a second processor (e.g., artificial intelligence dedicated processor).

The one or more processors 130 may be implemented as a single core processor that includes one core, or implemented as one or more multicore processors that include a plurality of cores (e.g., homogeneous multicore or heterogeneous multicore). If the one or more processors 130 are implemented as the multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or portion from among the plurality of cores) included in the multicore processors may independently read and perform a program command for implementing a method according to one or more embodiments, or read and perform a program command for implementing a method according to one or more embodiments of the disclosure due to a whole (or portion) of the plurality of cores being interconnected.

When a method according to one or more embodiments of the disclosure includes a plurality of operations, the plurality of operations may be performed by one core from among the plurality of cores or performed by the plurality of cores included in the multicore processors. For example, when a first operation, a second operation, and a third operation are performed by a method according to one or more embodiments, the first operation, the second operation, and the third operation may all be performed by a first core included in the multicore processors, or the first operation and the second operation may be performed by the first core included in the multicore processors and the third operation may be performed by a second core included in the multicore processors.

In the embodiments of the disclosure, the processor may refer to a system on chip (SoC), a single core processor, or multicore processors in which the one or more processors and other electronic components are integrated or a core included in the single core processor or the multicore processors, and the core herein may be implemented as the CPU, the GPU, the APU, the MIC, the DSP, the NPU, the hardware accelerator, the machine learning accelerator, or the like, but the embodiments of the disclosure are not limited thereto. For convenience of description, the one or more processors 130 will be designated as the processor 130 below.

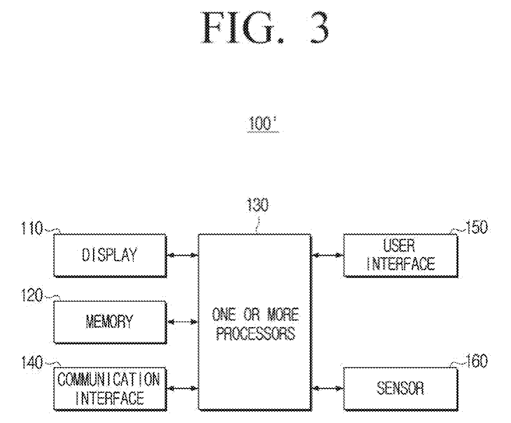

The processor 130 may calculate a correction coefficient corresponding to all grayscales based on the low grayscale correction coefficient and the high grayscale correction coefficient for each LED pixel. For example, the processor 130 may calculate a correction coefficient corresponding to an entire grayscale by interpolating the high grayscale correction coefficient and a low grayscale correction coefficient for each pixel as shown in FIG. 3. In this case, luminance and color characteristics of the entire grayscale may be corrected and ultimately, uniformity characteristics for the entire grayscale of the LED display may become superior. Specifically, by using the correction coefficient of the low grayscale that is lower than before, a pixel calibration correction performance in the low grayscale and the ultra-low grayscale may be improved in the LED display and the luminance and color characteristics across the entire grayscale may be improved that is visible to the naked eye, and ultimately, the uniformity characteristics of the LED display may be improved across the entire grayscale.

FIG. 3 is a block diagram illustrating a detailed configuration of a display apparatus according to one or more embodiments.

Referring to FIG. 3, the display apparatus 100’ may include the display 110, the memory 120, the one or more processors 130, a communication interface 140, a user interface 150, and a sensor 160. Detailed descriptions of configurations that overlap with the configurations shown in FIG. 2 from among the configurations shown in FIG. 3 will be omitted.

The communication interface 140 may be implemented in various interfaces according to an implementation example of the display apparatus 100’. For example, the communication interface 140 may perform communication with an external apparatus, an external storage media (e.g., USB memory), an external server (e.g., cloud server), and the like through communication methods such as, for example, and without limitation, Bluetooth, AP-based Wi-Fi (Wireless LAN network), Zigbee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/ European Broadcasting Union (AES/EBU), optical, coaxial, or the like. The communication interface 140 according to an example may perform communication with another electronic apparatus, an external server, and/or a remote control device, and the like.

The user interface 150 may be implemented with a device such as a button, a touch pad, a mouse and a keyboard, or implemented as a touch screen capable of performing the above-described display function and an operation input function together therewith.

The sensor 160 may include sensors of various types such as, for example, and without limitation, a touch sensor, a proximity sensor, an acceleration sensor (or gravity sensor), a geomagnetic sensor, a gyro sensor, a pressure sensor, a position sensor, a distance sensor, an illuminance sensor, and the like

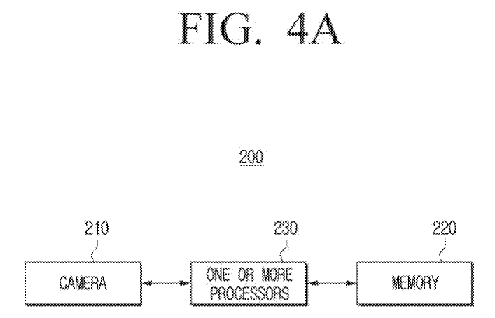

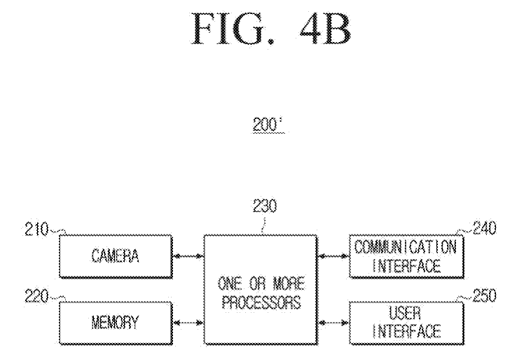

FIG. 4A is a block diagram illustrating a configuration of an electronic apparatus according to one or more embodiments.

Referring to FIG. 4A, an electronic apparatus 200 may include a camera 210, memory 220, and one or more processors 230. Because the configurations and functions of the memory 220 and the one or more processors 230 are same/similar with the configurations and functions of the memory 120 and the one or more processors 130 shown in FIGS. 2 and 3, detailed descriptions thereof will be omitted.

The camera 210 may be turned-on according to a pre-set event and perform capturing. The camera 210 may convert a captured image into an electrical signal and generate image data based on the converted signal. For example, a subject may be converted to an electrical image signal through a semiconductor optical device (a charge coupled device (CCD)), and the image signal converted as described above may be signal processed after being amplified and converted to a digital signal. For example, a camera 210 may include at least one from among a general (or basic) camera and an ultra-wide angle camera.

According to an example, the electronic apparatus 200 may be implemented to perform functions of a measuring device, a colorimeter, a color difference meter, and the like.

The camera 210 may obtain captured data (or measured data) by capturing a screen of the display apparatus 100 according to control of a processor 230. However, the camera according to another example may be provided in an external apparatus, and may receive captured data from the external apparatus.

The memory 220 may store captured data obtained by the camera 210. In addition, the memory 220 may store various data obtained through the processor 230 based on the captured data. In addition, the memory 220 may store various information such as formulae, algorithms, trained neural network models, and the like to obtain various data from the captured data.

The processor 230 may obtain the first correction coefficient that corresponds to each of the plurality of LED pixels included in the display apparatus and corresponds to a high grayscale of greater than or equal to a threshold grayscale based on the captured data (or measured data) obtained through the camera 210.

The processor 230 may obtain the second correction coefficient that corresponds to each of the plurality of LED pixels and corresponds to the low grayscale. For example, the low grayscale may be a low grayscale lower than the conventional general low grayscale. For example, the above may be divided into a high grayscale of greater than or equal to a first threshold grayscale, a low grayscale of less than the first threshold grayscale and greater than or equal to a second threshold grayscale, and an ultra-low grayscale of less than the second threshold grayscale, and the second correction coefficient may be a correction coefficient that corresponds to the ultra-low grayscale of less than the second threshold grayscale.

In an example, the processor 230 may obtain the second correction coefficient based on the first correction coefficient and the third correction coefficient corresponding to the low grayscale measured for each pixel group including the plurality of LED pixels. For example, the processor 230 may obtain the third correction coefficient by measuring a low grayscale value by simultaneously turning-on a plurality of LED pixels included in a pixel group for each R, G, and B color. For example, the processor 230 may obtain the second correction coefficient based on the first correction coefficient for each pixel, the third correction coefficient for each pixel, and calculation of the first correction coefficient and the third correction coefficient for each pixel. For example, the processor 230 may obtain the third correction coefficient by measuring the low grayscale value by simultaneously turning-on an n x n number of pixels from a position spaced apart by an m number of pixels for each R, G, and B color.

For example, the first correction coefficient for each pixel may include a high grayscale correction coefficient for each pixel. For example, the third correction coefficient for each pixel may include a low grayscale correction coefficient for each pixel measured for each pixel group including a plurality of LED pixels. For example, the calculation of first correction coefficient and the third correction coefficient for each pixel may include a low grayscale correction coefficient corresponding to a plurality of pixels included in each pixel group.

In another example, the processor 230 may obtain the second correction coefficient based on the first correction coefficient and a white (W) luminance value corresponding to the low grayscale measured for each pixel group. For example, the second correction coefficient may be a correction coefficient corresponding to the low grayscale that is lower than the conventional general low grayscale. For example, the processor 230 may obtain the second correction coefficient based on the W luminance value corresponding to the high grayscale for each pixel and the W luminance value corresponding to the low grayscale measured for each pixel group. For example, the processor 230 may obtain a luminance value for each R, G, and B color corresponding to the low grayscale for each pixel based on the high grayscale R, G, B, and W luminance values and the W luminance value corresponding to the low grayscale measured for each pixel group, and obtain the second correction coefficient based on the luminance value for each R, G, and B color corresponding to the obtained low grayscale for each pixel.

FIG. 4B is a block diagram illustrating a detailed configuration of an electronic apparatus according to one or more embodiments.

Referring to FIG. 4B, an electronic apparatus 200’ may include the camera 210, the memory 220, the one or more processors 230, a communication interface 240, and a user interface 250. Because the configurations and functions of the camera 210, the memory 220, the one or more processors 230, the communication interface 240, and the user interface 250 are same/similar with the configurations and functions of the camera 210, the memory 120, the one or more processors 130, the communication interface 140, and the user interface 150, detailed descriptions thereof will be omitted.

According to an example, the processor 230 may capture a screen of the display apparatus 100 by turning-on the camera 210 based on a user command received through the user interface 250.

According to an example, the processor 230 may transmit various data, for example, the first correction coefficient, the second correction coefficient, and the like obtained through calculation from the captured data to an external apparatus, for example the display apparatus 100, through the communication interface 240.

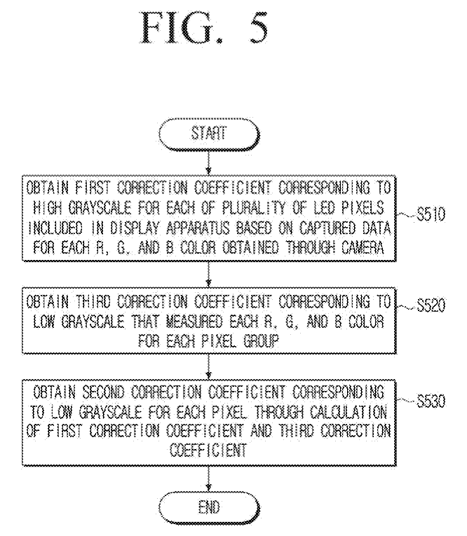

FIG. 5 is a flowchart illustrating a calibration method of a display apparatus that used an electronic apparatus according to an embodiment.

Referring to FIG. 5, the electronic apparatus 200 may obtain the first correction coefficient corresponding to the high grayscale for each of the plurality of LED pixels (S510).

Then, the electronic apparatus 200 may obtain the third correction coefficient corresponding to the low grayscale measured for each pixel group including the plurality of LED pixels (S520).

Then, the electronic apparatus 200 may obtain the second correction coefficient corresponding to the low grayscale for each pixel through calculation of the first correction coefficient and the third correction coefficient (S530).

According to an example, the electronic apparatus 200 may obtain the second correction coefficient based on calculation of the first correction coefficient for each pixel and the third correction coefficient for each pixel. For example, the electronic apparatus 200 may obtain the second correction coefficient based on calculation of the first correction coefficient for each pixel and the third correction coefficient for each pixel. Here, the calculation may include calculations such as additions, multiplications, divisions, and the like.

For example, the first correction coefficient for each pixel may include the high grayscale correction coefficient for each pixel. For example, the third correction coefficient for each pixel may include the low grayscale correction coefficient for each pixel measured for each pixel group including the plurality of LED pixels. For example, the calculation of the first correction coefficient and the third correction coefficient for each pixel may include a calculation value of the low correction coefficient corresponding to a plurality of pixels included in each pixel group.

According to an example, the electronic apparatus 200 may obtain the third correction coefficient by measuring the low grayscale value by simultaneously turning-on the plurality of LED pixels included in the pixel group for each R, G, and B color.

According to an example, the electronic apparatus 200 may obtain the third correction coefficient for each pixel by measuring the low grayscale value by simultaneously turning-on an n x n number of pixels from a position spaced apart by an m number of pixels for each R, G, and B color.

For example, the electronic apparatus 200 (e.g., measuring device) may perform calibration by using a pattern that groups a plurality of pixels only in cases of low grayscale in order to measure a low grayscale that is lower than the prior art. In other words, when measuring the low grayscale that is lower than before, the luminance overall is lowered, but when the pattern for grouping the plurality of pixels is used, a grayscale for each pixel may correspond to the low grayscale that is lower than before, but the luminance corresponding to the grouped pixels may increase. Accordingly, a stable measurement may be possible even if it is a grayscale that is lower than the existing low grayscale. A number of pixels that are grouped and a number of pixels that are spaced apart may be determined with various methods based on a resolution of the display apparatus 100 and a resolution of the electronic apparatus 200.

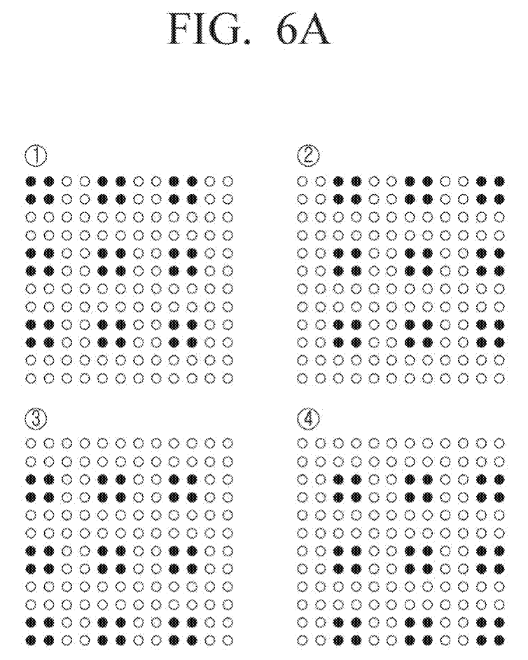

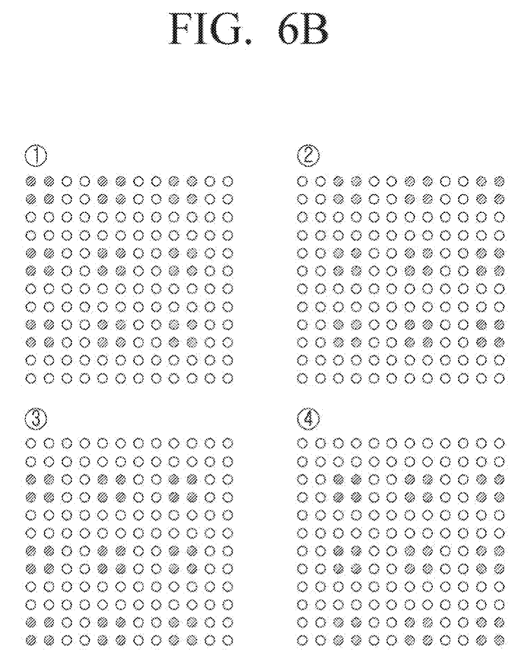

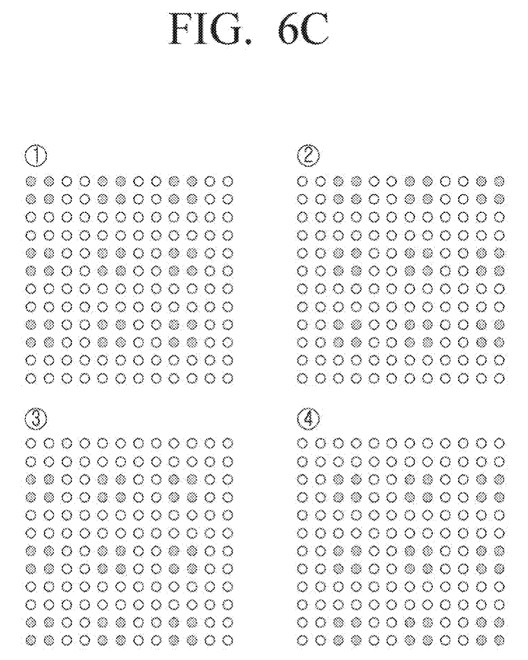

FIGS. 6A-6C are diagrams illustrating a low grayscale calibration method according to one or more embodiments.

According to an example, a high grayscale measurement may use a pattern that is spaced apart by 1 for each R, G, and B pixel identically as with prior art, and a low grayscale measurement may use a pattern for grouping a plurality of pixels by a pre-set number of pixels for each R, G, and B color.

Referring to FIGS. 6A-6C, the display apparatus 100 may provide a pattern that groups four pixels and spaces apart by two pixels, and the electronic apparatus 200 may obtain captured data, in other words, measured data based on the corresponding pattern.

For example, the display apparatus 100 may display a low grayscale pattern image displaying an R pixel as the low grayscale in the order of 1 → 2 → 3 →4 as shown in FIG. 6A.

For example, the display apparatus 100 may display a low grayscale pattern image displaying a G pixel as the low grayscale in the order of 1 → 2 → 3 →4 as shown in FIG. 6B.

For example, the display apparatus 100 may display a low grayscale pattern image displaying a B pixel as the low grayscale in the order of 1 → 2 → 3 →4 as shown in FIG. 6C.

The low grayscale pattern images shown in FIGS. 6A-6C are merely one example, and the number of pixels grouped and the number of pixels that are spaced apart in the pattern image may be determined with various methods based on the resolution of the display apparatus 100 and the resolution of the electronic apparatus 200.

As described above, when measuring a luminance value in the low grayscale by grouping a plurality of pixels, the grouped pixels may have the same low grayscale correction coefficient. In this case, there may be a problem of an agglomerated pixel unit visible to the naked eye in the low grayscale and an intermediate grayscale being perceived. For example, because the low grayscale correction coefficient and the high grayscale correction coefficient are interpolated and applied to the entire grayscale, it may affect not only the low grayscale but also the intermediate grayscale in the agglomerated pixel unit that is grouped. In order to prevent such a phenomenon from occurring, a process may be necessary for the agglomerated pixels to have a unique low grayscale correction coefficient corresponding to each individual pixel. Accordingly, the electronic apparatus 200 may obtain a final low grayscale correction coefficient based on the high grayscale correction coefficient (i.e., first correction coefficient) measured for each pixel and the third correction coefficient corresponding to the low grayscale measured for each pixel group.

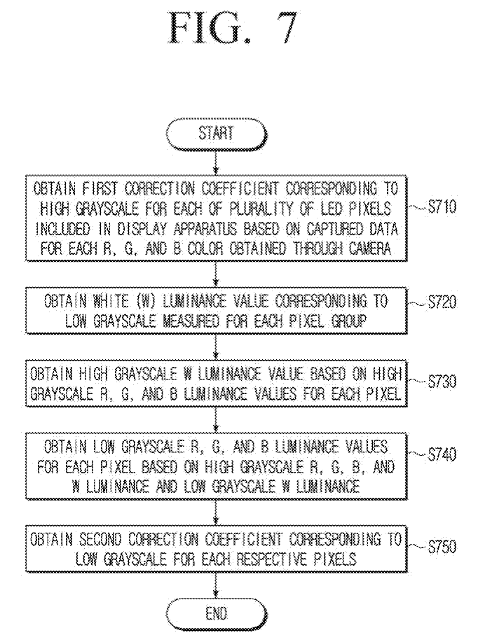

FIG. 7 is a flowchart illustrating a calibration method of a display apparatus that used an electronic apparatus according to one or more embodiments.

Referring to FIG. 7, the electronic apparatus 200 may obtain the first correction coefficient corresponding to the high grayscale for each plurality of LED pixels based on captured data obtained through the camera 210 (S710).

Then, the electronic apparatus 200 may obtain the white (W) luminance value corresponding to the low grayscale measured for each pixel group (S720).

Then, the electronic apparatus 200 may obtain a high grayscale white (W) luminance value based on the high grayscale R, G, and B luminance values for each pixel (S730).

Then, the electronic apparatus 200 may obtain low grayscale R, G, and B luminance values for each pixel based on the high grayscale R, G, B, and W luminance values and a low grayscale W luminance (S740).

According to an example, the electronic apparatus 200 may obtain the luminance values for each R, G, and B color corresponding to the low grayscale for each pixel through based on the high grayscale R, G, B, and W luminance values and the W luminance value corresponding to the low grayscale measured for each pixel group. For example, the electronic apparatus 200 may obtain the luminance value for each R, G, and B color corresponding to the low grayscale for each pixel through calculation of the high grayscale R, G, B, and W luminance values and the W luminance value corresponding to the low grayscale measured for each pixel group. Here, the calculation may include calculations such as additions, multiplications, divisions, and the like.

Then, the electronic apparatus 200 may obtain the second correction coefficient corresponding to the low grayscale for each pixel (S750).

According to an example, the electronic apparatus 200 may obtain the W luminance value corresponding to the low grayscale by simultaneously turning-on the R, G, and B pixels corresponding to the plurality of LED pixels included in the pixel group.

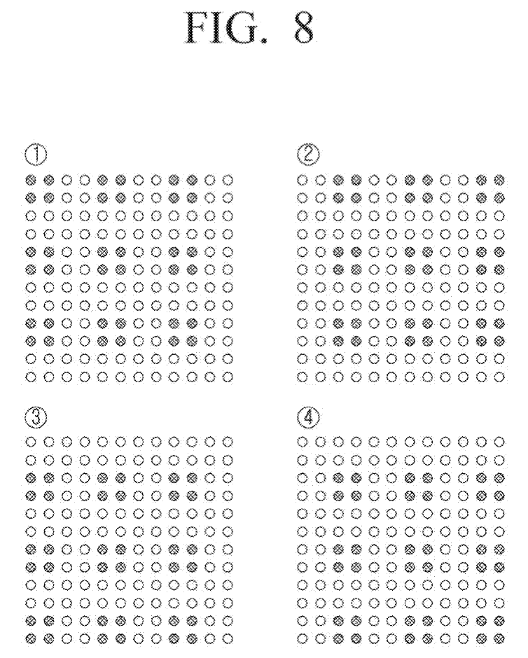

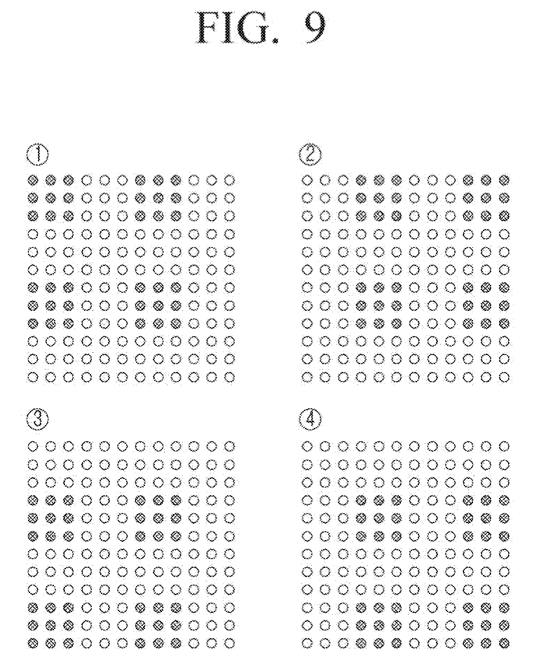

FIGS. 8 and 9 are diagrams illustrating a low grayscale calibration method according to one or more embodiments.

According to an example, the electronic apparatus 200 may calculate the low grayscale correction coefficient by measuring a W value rather than that of R, G, and B. For example, a W low grayscale may be a gray value. For example, the W value may be measured for the low grayscale in which R, G, and B grayscale measurements are not possible, but is not necessarily limited thereto. For example, the grayscale has to be lowered significantly and measured according to a characteristic of the display, but if R, G, and B grayscale measurement is not possible, a value that is measureable due to luminance being higher than that of R, G, and B may be measured. For example, this is because even if one from among the R, G, and B colors is not measurable, the method according to FIG. 5 may not be employed. Because W turns-on all R, G, and B, the grayscale may be lowered due to the luminance thereof being higher compared to that of R, G, and B.

Referring to FIG. 8, the display apparatus 100 may provide a pattern that groups four pixels and spaces apart by two pixels, and the electronic apparatus 200 may obtain captured data, in other words, measured data based on the corresponding pattern.

For example, the display apparatus 100 may display a low grayscale pattern image that displays W as the low grayscale in the order of 1 → 2 → 3 →4 by simultaneously turning-on the R, G, and B pixels as shown in FIG. 8.

Referring to FIG. 9, the display apparatus 100 may provide a pattern that groups nine pixels and spaces apart by three pixels, and the electronic apparatus 200 may obtain captured data, in other words, measured data based on the corresponding pattern.

For example, the display apparatus 100 may display a low grayscale pattern image that displays W as the low grayscale in the order of 1 → 2 → 3 →4 by simultaneously turning-on the R, G, and B pixels as shown in FIG. 9.

Alternatively, various patterns such as a pattern that groups nine pixels and spaces apart by two pixels, and a pattern that groups twenty-five pixels and spaces apart by two pixels may be used.

The low grayscale pattern images shown in FIGS. 8 and 9 are merely one example, and the number of pixels grouped and the number of pixels that are spaced apart in the pattern image may be determined with various methods based on the resolution of the display apparatus 100 and the resolution of the electronic apparatus 200.

As shown in FIGS. 8 and 9, the grouped pixels may be measured with one luminance value. However, because the above is the W luminance value, a process for finally changing the low grayscale W luminance measured to calculate the correction coefficient for each R, G, and B to the low grayscale R, G, and B luminance may be necessary. To this end, the high grayscale R, G, B, and W luminance may be necessary.

However, because high grayscale measurement can be measured using a pattern that spaces apart by one for each R, G, and B pixel identically as the prior art, the high grayscale W luminance may not be present. In this case, the electronic apparatus 200 may use the high grayscale R, G, and B luminance and calculate the high grayscale W luminance. The electronic apparatus 200 may use the high grayscale W, R, G, and B luminance values and the low grayscale W luminance for each of the respective pixels and calculate the R, G, and B luminance corresponding to the low grayscale for each individual pixel through calculation. In this case, the correction coefficient of the low grayscale may be calculated using the low grayscale R, G, and B luminance values by using the same method as the method that was used to obtain the high grayscale correction coefficient using the high grayscale R, G, and B luminance values.

According to various embodiments described above, the correction coefficient may be calculated by measuring the low grayscale that is lower than before, the luminance and color characteristics of the entire grayscale may be corrected to be superior in the LED display, and ultimately, the uniformity characteristics of the LED display may become superior.

Methods according to the various embodiments of the disclosure described above may be implemented with only a software upgrade, or a hardware upgrade for the conventional display apparatus and the conventional electronic apparatus.

In addition, the various embodiments of the disclosure described above may be performed through an embedded server provided in the electronic apparatus, or an external server of the electronic apparatus.

According to an embodiment of the disclosure, the various embodiments described above may be implemented with software including instructions stored in a machine-readable storage media (e.g., computer). The machine may call the stored instructions from the storage media, and as an apparatus operable according to the called instructions, may include an electronic apparatus (e.g., electronic apparatus (A)) according to the above-mentioned embodiments. Based on a command being executed by the processor, the processor may directly or using other elements under the control of the processor perform a function corresponding to the command. The command may include a code generated by a compiler or executed by an interpreter. The machine-readable storage media may be provided in a form of a non-transitory storage media. Herein, ‘non-transitory’ merely means that the storage media is tangible and does not include a signal, and the term does not differentiate data being semi-permanently stored or being temporarily stored in the storage media.

In addition, according to an embodiment of the disclosure, the method according to the various embodiments described above may be provided included a computer program product. The computer program product may be exchanged between a seller and a purchaser as a commodity. The computer program product may be distributed in a form of the machine-readable storage media (e.g., a compact disc read only memory (CD-ROM)), or distributed online through an application store (e.g., PLAYSTORE™). In the case of online distribution, at least a portion of the computer program product may be stored at least temporarily in the machine-readable storage media such as a server of a manufacturer, a server of an application store, or a memory of a relay server, or temporarily generated.

In addition, each of the elements (e.g., a module or a program) according to the various embodiments described above may be formed as a single entity or a plurality of entities, and a portion of sub-elements of the above-mentioned corresponding sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A display apparatus comprising:
a display comprising a plurality of light-emitting diode (LED) pixels;
memory storing a first correction coefficient that corresponds to each of the plurality of LED pixels and corresponds to a high grayscale that is greater than or equal to a threshold grayscale, and a second correction coefficient that corresponds to a low grayscale that is less than the threshold grayscale; and
one or more processors configured to drive the display by applying a correction coefficient for each grayscale obtained based on the first correction coefficient and the second correction coefficient to each of the plurality of LED pixels,
wherein the second correction coefficient is obtained based on the first correction coefficient and a third correction coefficient corresponding to a low grayscale measured for each red, green, and blue color for each pixel group comprising a plurality of LED pixels, or obtained based on the first correction coefficient and a white luminance value corresponding to a low grayscale measured for each pixel group.

2. The display apparatus of claim 1, wherein the second correction coefficient is obtained based on calculation of the first correction coefficient for each pixel and the third correction coefficient for each pixel.

3. The display apparatus of claim 2, wherein the first correction coefficient for each of the pixels comprises a high grayscale correction coefficient for each pixel,
wherein the third correction coefficient for each of the pixels comprises a low grayscale correction coefficient for each pixel measured for each red, green, and blue color for each pixel group that comprises a plurality of LED pixels, and
wherein a value of the first correction coefficient and the third correction coefficient comprises a low grayscale correction coefficient value corresponding to each of a plurality of pixels comprised in each pixel group.

4. The display apparatus of claim 1, wherein the second correction coefficient is obtained based on a luminance value for each red, green, and blue color corresponding to an obtained low grayscale for each pixel when a luminance value for each red, green, and blue color corresponding to a low grayscale for each pixel is obtained based on high grayscale red, green, blue, and white luminance values and a white luminance value corresponding to a low grayscale measured for each of the pixel groups.

5. The display apparatus of claim 1, wherein the third correction coefficient is obtained by measuring a low grayscale value by simultaneously turning-on a plurality of LED pixels comprised in a pixel group for each red, green, and blue color.

6. An electronic apparatus comprising:
a camera;
memory storing at least one instruction; and
one or more processors operatively coupled with the camera and the memory,
wherein the at least one instruction, when executed by the one or more processors individually or collectively, causes the electronic apparatus to:
obtain a first correction coefficient that corresponds to each of a plurality of light-emitting diode (LED) pixels comprised in a display apparatus and corresponds to a high grayscale that is greater than or equal to a threshold grayscale based on captured data obtained through the camera, and
obtain a second correction coefficient that corresponds to each of the plurality of LED pixels and corresponds to a low grayscale that is less than the threshold value, and
wherein the at least one instruction, when executed by the one or more processors individually or collectively, causes the electronic apparatus to:
obtain the second correction coefficient based on the first correction coefficient and a third correction coefficient corresponding to a low grayscale measured for each pixel group comprising a plurality of LED pixels, or
obtain the second correction coefficient based on the first correction coefficient and a white luminance value corresponding to a low grayscale measured for each pixel group.

7. The electronic apparatus of claim 6, wherein the at least one instruction, when executed by the one or more processors individually or collectively, causes the electronic apparatus to:
obtain the second correction coefficient based on calculation of the first correction coefficient for each pixel and the third correction coefficient for each pixel.

8. The electronic apparatus of claim 7, wherein the first correction coefficient for each of the pixels comprises a high grayscale correction coefficient for each pixel,
wherein the third correction coefficient for each of the pixels comprises a low grayscale correction coefficient for each pixel measured for each pixel group that comprises a plurality of LED pixels, and
wherein calculation of the first correction coefficient and the third correction coefficient comprises a low grayscale correction coefficient value corresponding to a plurality of pixels comprised in each pixel group.

9. The electronic apparatus of claim 6, wherein the at least one instruction, when executed by the one or more processors individually or collectively, causes the electronic apparatus to:
obtain a luminance value for each red, green, and blue color corresponding to a low grayscale for each pixel based on high grayscale red, green, blue, and white luminance values and a white luminance value corresponding to a low grayscale measured for each of the pixel groups, and
obtain the second correction coefficient based on a luminance value for each red, green, and blue color corresponding to the obtained low grayscale for each pixel.

10. The electronic apparatus of claim 6, wherein the at least one instruction, when executed by the one or more processors individually or collectively, causes the electronic apparatus to:
obtain the third correction coefficient by measuring a low grayscale value by simultaneously turning-on a plurality of LED pixels comprised in a pixel group for each red, green, and blue color.

11. The electronic apparatus of claim 10, wherein the at least one instruction, when executed by the one or more processors individually or collectively, causes the electronic apparatus to:
obtain the third correction coefficient by measuring a low grayscale value by simultaneously turning-on an n x n-number of pixels from a position spaced apart by a m-number of pixels for each red, green, and blue color.

12. The electronic apparatus of claim 6, wherein the at least one instruction, when executed by the one or more processors individually or collectively, causes the electronic apparatus to:
obtain a white luminance value corresponding to the low grayscale by simultaneously turning-on red, green, and blue pixels corresponding to a plurality of LED pixels comprised in a pixel group.

13. A calibration method of a plurality of light-emitting diode (LED) pixels of a display apparatus, the calibration method comprising:
obtaining a first correction coefficient that corresponds to each of a plurality of LED pixels and corresponds to a high grayscale that is greater than or equal to a threshold grayscale; and
obtaining a second correction coefficient that corresponds to each of the plurality of LED pixels and corresponds to a low grayscale that is less than the threshold grayscale,
wherein the obtaining the second correction coefficient comprises:
obtaining the second correction coefficient based on the first correction coefficient and a third correction coefficient corresponding to a low grayscale measured for each red, green, and blue color for each pixel group comprising a plurality of LED pixels, or
obtaining the second correction coefficient based on the first correction coefficient and a white luminance value corresponding to a low grayscale measured for each pixel group.

14. The calibration method of claim 13, wherein the obtaining the second correction coefficient comprises obtaining the second correction coefficient based on calculation of the first correction coefficient for each pixel and the third correction coefficient for each pixel.

15. The calibration method of claim 14 wherein the first correction coefficient for each of the pixels comprises a high grayscale correction coefficient for each pixel,
wherein the third correction coefficient for each of the pixels comprises a low grayscale correction coefficient for each pixel measured for each pixel group that comprises a plurality of LED pixels, and
wherein calculation of the first correction coefficient and the third correction coefficient comprises a low grayscale correction coefficient value corresponding to a plurality of pixels comprised in each pixel group.

16. The calibration method of claim 13, wherein the obtaining the second correction coefficient comprises
obtaining a luminance value for each red, green, and blue color corresponding to a low grayscale for each pixel based on high grayscale red, green, blue, and white luminance values and a white luminance value corresponding to a low grayscale measured for each of the pixel groups, and
obtaining the second correction coefficient based on a luminance value for each red, green, and blue color corresponding to the obtained low grayscale for each pixel.

17. The calibration method of claim 13, wherein the obtaining the second correction coefficient comprises
obtaining the third correction coefficient by measuring a low grayscale value by simultaneously turning-on a plurality of LED pixels comprised in a pixel group for each red, green, and blue color.

18. The calibration method of claim 17, wherein the obtaining the second correction coefficient comprises
obtaining the third correction coefficient by measuring a low grayscale value by simultaneously turning-on an n x n-number of pixels from a position spaced apart by a m-number of pixels for each red, green, and blue color.

19. The calibration method of claim 12, wherein the obtaining the second correction coefficient comprises
obtaining a white luminance value corresponding to the low grayscale by simultaneously turning-on red, green, and blue pixels corresponding to a plurality of LED pixels comprised in a pixel group.
